(19) United States
(12) Patent Application Publication
(10) Pub. No.: US 2013/0278017 A1
(43) Pub. Date: Oct. 24, 2013

(54) PILLAR STRUCTURE FOR VEHICLE BODY REAR PORTION

(71) Applicant: SUZUKI MOTOR CORPORATION, Shizuoka-ken (JP)

(72) Inventors: Hideki Arikai, Shizuoka-ken (JP); Kentaro Jojiki, Shizuoka-ken (JP); Yu Hashiba, Shizuoka-ken (JP)

(73) Assignee: SUZUKI MOTOR CORPORATION, Shizuoka-ken (JP)

(21) Appl. No.: 13/860,916

(22) Filed: Apr. 11, 2013

(30) Foreign Application Priority Data
Apr. 19, 2012 (JP) 2012-095532

(51) Int. Cl. B62D 25/04

(52) U.S. Cl. CPC B62D 25/04
USPC 296/193.06

(57) ABSTRACT

The present invention provides a pillar structure for a vehicle body rear portion which can suppress deformation of a pillar when a load is applied outward to a slide door in a state in which said slide door is closed.

The slide door opens and closes an opening provided in a vehicle side surface. A pillar portion is composed of a closed section of an inner and outer panel. A fixing mechanism fixes a rear portion of said slide door at a closed position. Said fixing mechanism is provided on a surface facing a vehicle body front side of said pillar portion. A pillar reinforcement body forming a quadrangular closed section is mounted to an inner surface of said pillar portion. An interior-side reinforcement member is disposed between said pillar reinforcement body and said inner panel so as to have a gap in a vehicle width direction.

### TECHNICAL FIELD

The present invention relates to a pillar structure for a vehicle body rear portion which improves the strength of holding a slide door against a load from a vehicle interior side.

### BACKGROUND ART

Conventionally, as side doors placed at a vehicle body side portion, slide doors which open and close a door opening portion by slidingly moving a door body in a vehicle body longitudinal direction have been generally well known, and are often used as side doors of, for example, so-called minivan-type automobiles.

In the vehicles with such slide doors, a plurality of guide rails that extend in the vehicle body longitudinal direction are disposed at the vehicle body side portion, and rollers that can roll on said guide rails are disposed on the door body side of the slide door, so that when the door is opened or closed, said rollers roll on the guide rails, and said slide door thereby slidingly moves along the guide rails in the vehicle body longitudinal direction.

Said guide rails employ such a configuration that a guide rail having a square U shape in section is provided so as to extend in the vehicle body longitudinal direction at an intermediate position in an upper-lower direction at the vehicle body side portion on a rear portion side of the door opening portion, and an intermediate portion roller that can roll on the guide rail is provided at a back surface position on a rear portion side of the slide door while being supported by a horizontal shaft.

Also, guide rails having a square U shape in section that opens to a lower side are respectively provided so as to extend in the vehicle body longitudinal direction at upper and lower edge portions of the door opening portion, and upper and lower rollers that can roll along the upper and lower guide rails are provided at a front end portion of the back surface position on the door body side of the slide door while being supported vertical shaft, so that the upper and lower rollers roll along the guide rails to guide the slide door.

In said slide door, a striker that projects to the door opening side is vertically provided on a vertical surface at an opening end edge of the door opening portion, and a hook member having an engagement claw that is curved toward a vehicle interior side corresponding to the striker is provided on a door end surface of the door facing the vertical surface, so that when the door is closed, the engagement claw of the hook member is made facing the striker from a vehicle outer side, and when the door is pushed into the vehicle interior side in a vehicle side crash or the like, the engagement claw enters into the striker to restrict the movement into the door opening portion with an inner corner portion of the engagement claw being engaged with a distal end vertical piece of the striker (Patent Document 1).

Meanwhile, in the vehicles with the slide doom as described above, since the slide door is supported at the three points of the upper and lower portions of the front end portion and the intermediate portion of the rear end portion, a force in a vehicle body outward direction is applied to the rollers through the door body and the outward force acts on upper and lower guide surface portions of the intermediate portion guide rail at the rear end portion of the slide door when a load is applied outward in a vehicle width direction to said slide door in a state in which the slide door is closed. In a case in which the outward force is greater than a certain level, a distance between the upper and lower guide surface portions increases, thereby causing so-called opening of the guide rail.

When the opening of the guide rail occurs as described above, the roller is displaced outward in the vehicle width direction according to the degree of opening, and in extreme cases, the roller may run off the guide rail. There is a problem that a gap between the vehicle body side surface and the door body in a door closed state increases as the roller is displaced more outward in the vehicle width direction, which is not preferable in stably holding the slide door.

To solve the problem, there has been known a conventional technique in which an opening prevention bracket that couples facing guide surface portions provided in a guide rail together, and thereby prevents the opening of the guide rail caused when a distance between the guide surface portions increases is provided at a front end portion of an intermediate portion guide rail (see Patent Document 2).

Also, there has been known a conventional technique in which a striker is arranged on a vehicle body-side vertical wall surface facing a door opening portion so as to form a square U-shaped planar surface as viewed from a vehicle body side surface, an insertion hole in which the striker is inserted and arranged in a state in which a slide door is closed is provided in a slide door-side vertical wall surface, and a cutout portion that can be engaged with the striker is provided in the insertion hole on a vehicle interior side, so that when a load is applied to the slide door from the vehicle interior side to a vehicle exterior side, the striker is engaged with the cutout portion (see Patent Document 3).

### PRIOR ART

### Patent Document

[Patent Document 1] Japanese Patent Application Laid-Open No. 2006-35881
[Patent Document 2] Japanese Patent Application Laid-Open No, 2010-83167
[Patent Document 3] Japanese Patent Application Laid-Open No. 2009-143294

### SUMMARY OF INVENTION

### Problems to be Solved by the Invention

However, in the technique in Patent Document 2, it costs a lot to manufacture the opening prevention bracket, and there is also a risk that the entire guide rail is deformed toward the vehicle body outer side together with the slide door due to insufficient rigidity of a side panel itself where the guide rail is provided when a large outward load is applied to the slide door. Also, in the technique in Patent Document 3, there is a risk that the rigidity of the vehicle body side surface is reduced in association with the movement of the striker to thereby deform the vehicle body side surface when a large load is applied to the striker.

To solve the above problems, it is an object of the present invention to provide a pillar structure for a vehicle body rear portion which can suppress deformation of a pillar when a load is applied outward in a vehicle width direction to a slide door in a state in which said slide door is closed.

### Means for Solving the Problems

To achieve the above object, the present invention provides a pillar structure for a vehicle body rear portion in which a slide door that opens and closes an opening portion provided in a vehicle side surface is provided, a pillar portion on a vehicle body rear portion side of the opening portion is composed of a closed section of an inner panel and an outer panel, and a fixing mechanism that fixes a rear portion of said slide door at a closed position of said slide door is provided at said pillar portion on the vehicle body rear portion side, wherein said fixing mechanism is provided on a surface facing a vehicle body front side of said pillar portion on the vehicle body rear portion side, a pillar reinforcement body that forms a quadrangular closed section in horizontal section is internally mounted to an inner surface of said pillar portion on the vehicle body rear portion side to which said fixing mechanism is mounted, and an interior-side reinforcement member is disposed between said pillar reinforcement body and said inner panel so as to have a gap in a vehicle width direction between the interior-side reinforcement member and said pillar reinforcement body.

Also, in the present invention, said pillar reinforcement body is formed by combining a vehicle body inner-side reinforcement member and a vehicle body outer-side reinforcement member whose horizontal sections are respectively formed in L shapes; and a front surface wall portion of said pillar portion on the vehicle body rear portion side is formed by said outer panel; a front surface portion of the vehicle body outer-side reinforcement member is overlapped on an inner wall surface of the front surface wall portion of said pillar portion on the vehicle body rear portion side; a rear surface portion of the vehicle body outer-side reinforcement member is extended to a vehicle body rear side; and the vehicle body inner-side reinforcement member that forms said quadrangular closed section together with said vehicle body outer-side reinforcement member being joined to a front end portion and a rear end portion of said vehicle body outer-side reinforcement member.

Moreover, in the present invention, a corner portion on a vehicle body rear outer side of said quadrangular closed section formed by said vehicle body outer-side reinforcement member and said vehicle body inner-side reinforcement member is formed as a substantially right angle in horizontal section.

Furthermore, a reinforcement member is disposed in a vehicle body longitudinal direction at a bottom of a window portion of said slide door, and said fixing mechanism, said vehicle body outer-side reinforcement member, said vehicle body inner-side reinforcement member, and said interior-side reinforcement member are overlapped in vehicle body front view at a height of a lower end position of the reinforcement member.

### Advantageous Effects of Invention

In accordance with the first invention, the pillar reinforcement body that forms the quadrangular closed section in horizontal section is internally mounted to the inner surface of said pillar portion on the vehicle body rear portion side to which the fixing mechanism is mounted, and the interior-side reinforcement member is disposed between said pillar reinforcement body and said inner panel so as to have the gap in the vehicle width direction between the interior-side reinforcement member and said pillar reinforcement body, so that when the slide door is pushed out to a vehicle body outer side, a load is applied to the fixing mechanism, and the pillar reinforcement body having the quadrangular closed section is rotationally moved to come into contact with the interior-side reinforcement member, thereby suppressing deformation.

In accordance with the second invention, the pillar reinforcement body is formed by combining the vehicle body inner-side reinforcement member and the vehicle body outer-side reinforcement member whose horizontal sections are respectively formed in substantially L shapes, so that the assembling process is simplified, and the rigidity of the corner portion can be ensured. Also, the front surface wall portion of said pillar portion on the vehicle body rear portion side is formed by said outer panel, the front surface portion of the vehicle body outer-side reinforcement member is overlapped on the inner wall surface of the front surface wall portion of said pillar portion on the vehicle body rear portion side, the rear surface portion of the vehicle body outer-side reinforcement member is provided extending to the vehicle body rear side, and the vehicle body inner-side reinforcement member that forms said quadrangular closed section together with said vehicle body outer-side reinforcement member is joined to the front end portion and the rear end portion of said vehicle body outer-side reinforcement member, so that the rigidity of a fixing mechanism mounting portion can be ensured.

In accordance with the third invention, the corner portion on the vehicle body rear outer side of the quadrangular closed section is formed as the substantially right angle in horizontal section, so that the load can be transmitted to the interior-side reinforcement member and thereby dispersed while the quadrangular closed section is being held.

In accordance with the fourth invention, since the deformation of the slide door occurs on a lower portion side of the reinforcement member at the bottom of the window frame, the movement of the fixing mechanism is restricted, and the slide door can be also restricted from being broken when the pillar reinforcement body having the quadrangular closed section comes into contact with the interior-side reinforcement member.

### BRIEF DESCRIPTION OF DRAWINGS

FIG. 1 is an exploded perspective view illustrating a pillar structure for a vehicle body rear portion according to the present invention.

FIG. 2 is a front view illustrating the pillar structure for the vehicle body rear portion according to the present invention.

FIG. 3 is a front view illustrating the pillar structure from which a side body outer panel in FIG. 2 is removed.

FIG. 4 is a sectional view taken along a line X-X in FIG. 3.

### MODE FOR CARRYING OUT THE INVENTION

In the following, an embodiment of the present invention will be described in detail by reference to the drawings.

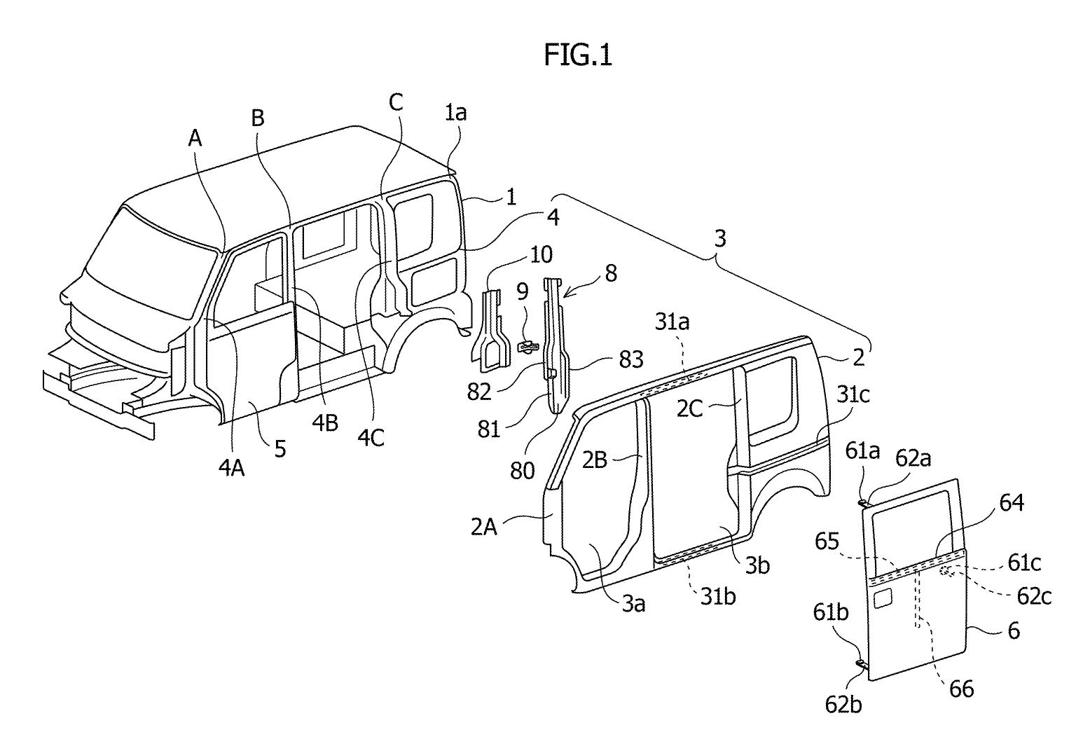

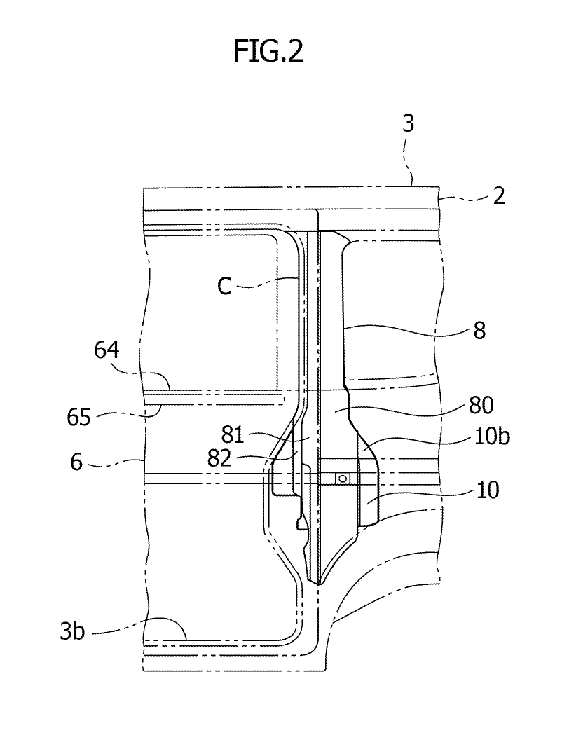

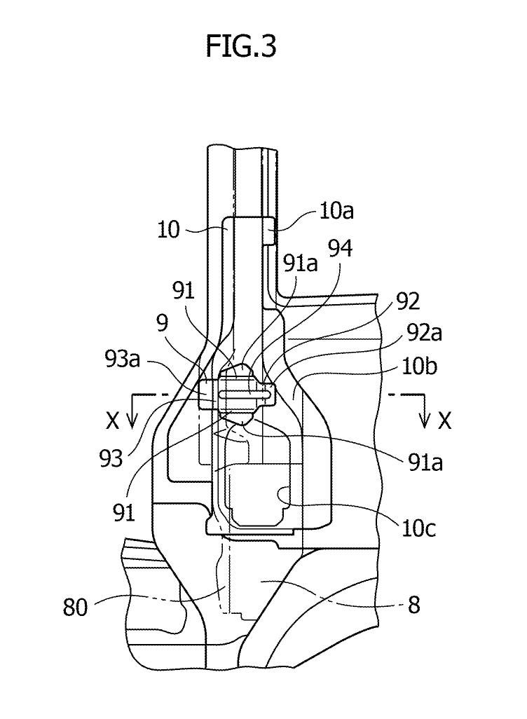

The configuration of a pillar portion in a vehicle body rear portion is shown in FIG. 1, and the specific structure of the pillar portion is shown in FIGS. 2 to 4.

In FIGS. 1 to 4, reference numeral 1 denotes a vehicle body of a minivan from u which a side body outer panel 2 is removed. A side body inner panel 4 that forms a side body 3 together with the side body outer panel 2 is attached to a side surface 1a on both right and left sides of the vehicle body 1. Opening portions 3a and 3b as a gate are respectively formed in front and rear portions of said side body 3 on both the right and left sides, and a front pillar portion A and a quarter pillar portion B that define the opening portion 3a on the front portion side, and a rear pillar portion C that defines the opening portion 3b on the rear portion side together with the quarter pillar portion B are provided in said side body 3 on both the right and left sides.

A panel-type front door 5 that is supported on said front pillar portion A rotatably to a vehicle body outer side via a hinge mechanism (not shown) is provided at said opening portion 3a on the front portion side, and a sliding-type slide door 6 that slides in a longitudinal direction of the vehicle body 1 to open and close the opening portion 3b is provided at the opening portion 3b on the rear portion side. Slide rails 31a, 31b, and 31c are longitudinally provided at upper and lower positions of the opening portion 3b and on a side surface of the side body 3. Meanwhile, in the slide door 6, an upper portion arm 62a, a lower portion arm 62b, and an intermediate portion arm 62c that pivotally support an upper portion roller 61a, a lower portion roller 61b, and an intermediate portion roller 61c in engagement with the above slide rails 31a, 31b, and 31c are respectively provided at upper and lower portions of a front portion of a back surface of the slide door 6, and at an intermediate portion of a rear portion of the back surface.

The pillar portion on a vehicle body front portion side (the quarter pillar portion) B of said opening portion 3b is composed of a pillar portion 2B of the side body outer panel 2, and a pillar portion 4B of the side body inner panel 4.

The pillar portion on a vehicle body rear portion side (the rear pillar portion) C of said opening portion 3b is composed of a pillar portion 2C of the side body outer panel 2, and a pillar portion 4C of the side body inner panel 4.

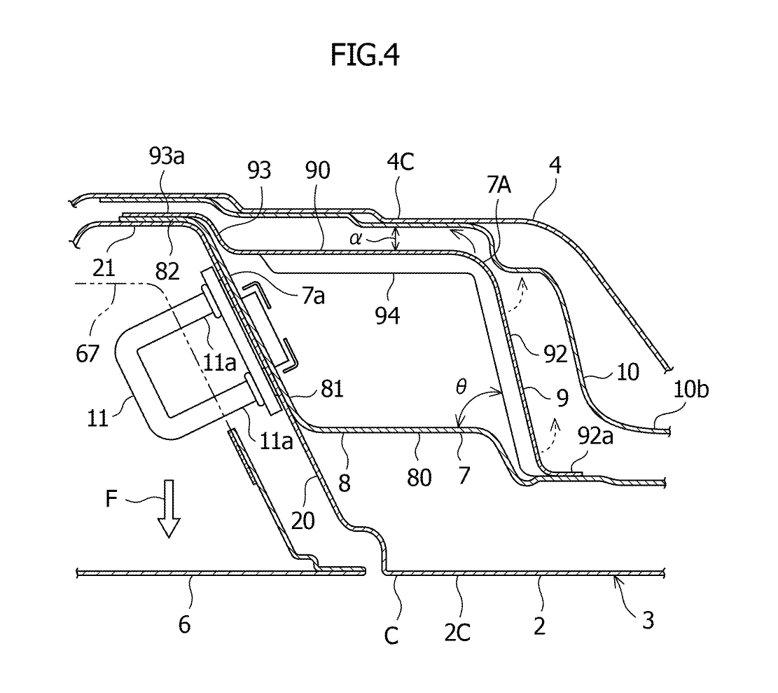

As shown in FIG. 4, a pillar reinforcement body 7 that forms a closed surface having a quadrangular closed section in horizontal section is internally mounted to the pillar portion C on the vehicle body rear portion side of said opening portion 3b. In the pillar reinforcement, body 7, the quadrangular closed section is formed between a vehicle body outer-side reinforcement member 8 whose horizontal section is formed in a substantially L shape and a vehicle body inner-side reinforcement member 9 whose horizontal section is formed in a substantially L shape, and an interior-side reinforcement member 10 is disposed between the pillar reinforcement body 7 and the side body inner panel 4. The interior-side reinforcement member 10 has a gap a in a vehicle width direction between the interior-side reinforcement member 10 and said pillar reinforcement body 7.

A front surface portion of the pillar portion 2C of the side body outer panel 2 is formed in a vertical wall surface 20 that is directed toward a vehicle body front side, and a front surface portion 7a of the pillar reinforcement body 7 is overlapped on said vertical wall surface 20 of the pillar portion 2C on a back surface side.

Said vehicle body outer-side reinforcement member 8 has a vertically-long panel 80 that is joined to an inner wall surface of the pillar portion 2C of the side body outer panel 2, and reinforces the pillar portion C on the vehicle body rear portion side from an upper end portion to a lower end portion. In said vehicle body outer-side reinforcement member 8, a vertical wall surface 81 is provided on the front side of the panel 80 along said vertical wall surface 20 of said pillar portion 2C, and a flange portion 82 is provided ahead of the vertical wall surface 81 such that the flange portion 82 is joined to a back surface of a flange portion 21 of the pillar portion 2C of the side body outer panel 2. In said vehicle body outer-side reinforcement member 8, a rear portion side of the vertical wall surface 81 is bent in a substantially L shape to extend to a vehicle body rear side along the inner wall surface of the side body outer panel 2, and a flange portion 83 on the rear portion side is joined to the inner surface of the pillar portion 2C.

A striker 11 as a fixing mechanism that fixes the rear portion of said slide door 6 when the slide door 6 is closed is provided at the rear portion of a closed position of the slide door 6 on the vertical wall surface on the opening side of said pillar portion C on the vehicle body rear portion side.

Said striker 11 is fixed in a square U shape in plan view to the overlapped portion between said vertical wall surface 20 of the pillar portion 2C and the vertical wall surface 81 of the vehicle body outer-side reinforcement member 8 by locking distal ends of a pair of leg portions 11a by a fixing bracket that is formed in a square U shape by coupling one ends of the leg portions 11a together.

Said vehicle body inner-side reinforcement member 9 is internally mounted to said pillar portion C on the vehicle body rear portion side corresponding to the mounting position of said striker 11 so as to form the pillar reinforcement body 7. Said vehicle body inner-side reinforcement member 9 has a quadrangular panel surface 90 that faces the panel surface 80 of said vehicle body outer-side reinforcement member 8, a pair of side wall surfaces 91 that are provided extending toward the panel surface 80 at upper and lower positions of the panel surface 90, and a rear wall surface 92 that is provided extending toward the panel surface 80 of said vehicle body outer-side reinforcement member 8 at a rear end of the panel surface 90, and flange portions 91a provided at distal ends of said pair of side wall surfaces 91 and a flange portion 92a provided at a distal end of said rear wall surface 92 are joined to the panel surface 80 of said vehicle body outer-side reinforcement member 8.

Also, a flange portion 93a that is overlapped on the flange portion 82 of said vehicle body outer-side reinforcement member 8 via a stepped portion 93 is provided extending from a distal end of the panel surface 90, and the flange portion 93a as well as the flange portion 82 of said vehicle body outer-side reinforcement member 8 is joined to the flange portion 21 of the pillar portion 2C of the side body outer panel 2. A bead 94 is horizontally formed on the panel surface 90 and the rear wall surface 92 of said vehicle body inner-side reinforcement, member 9.

Said interior-side reinforcement member 10 is a reinforcement panel that is arranged between said pillar reinforcement body 7 and the side body inner panel 4 so as to be joined to the pillar portion 4C of the side body inner panel 4. In the interior-side reinforcement member 10, an upper end portion 10a is provided extending with a window frame width to the middle of a rear portion-side window frame of said pillar portion 4C, and a lower portion side from an intermediate portion Ilk in an upper-lower direction is formed with a larger width in the longitudinal direction of the vehicle body 1 such that said intermediate portion 10b is disposed so as to face said pillar reinforcement body 7 with the given gap u therebetween. A work hole 10c to which, for example, a seatbelt retractor is attached is formed in the lower portion side of said intermediate portion 10b.

In said slide door 6, a belt-like reinforcement member 65 is disposed in an inner portion along the vehicle body longitudinal direction on a lower portion side of a window frame 64, and a belt-like reinforcement member 66 is disposed from an intermediate portion toward a lower portion of the reinforcement member 65. Also, an insertion port 67 that receives said striker 11 when the slide door 6 is at the closed position is formed in the back surface side at a rear end portion of said slide door 6 (see FIG. 4). For example, an unillustrated latch mechanism is provided inside the insertion port 67, so that the latch mechanism is engaged with the striker 11 to hold the slide door 6 at the closed position when the slide door 6 is closed.

Next, in a case in which an outward excessive impact is applied to the slide door 6 from the vehicle interior, the slide door 6 is deformed to apply a load F to the striker 11 through the latch mechanism. When the load toward the vehicle body outer side is applied to a center portion in the upper-lower direction of the slide door 6 to deform the slide door 6 toward the vehicle body outer side, the upper and lower portions of the slide door 6 receive such a force that the upper and lower portions are bent toward a vehicle body inner side since the upper portion roller 61a and the lower portion roller 61b are engaged with the slide rails 31a and 31b.

The overlapped portion between the vertical wall surface 20 of the pillar portion 2C and the vertical wall surface 81 of the vehicle body outer-side reinforcement member 8 is deformed in the direction of a dashed arrow in the drawing along with the movement of the striker 11. Since the mounting surface of the striker 11 has high rigidity by the vertical wall surface 20 and the vertical wall surface 81, the movement of the striker 11 is transmitted to the pillar reinforcement body 7.

Subsequently the pillar reinforcement body 7 is rotationally moved in the direction of the dashed arrow in the drawing along with the rotational movement of the striker 11, and a corner portion 7A of the pillar reinforcement body 7 or the panel surface 90 of the vehicle body inner-side reinforcement member 9 is locked onto a panel surface of the intermediate portion 10b of the interior-side reinforcement member 10.

As described above, the pillar reinforcement body 7 is locked onto the interior-side reinforcement member 10 after being rotationally moved some distance, and further movement is restricted. Since the pillar reinforcement, body 7 is formed by the closed surface having the quadrangular closed section in horizontal section, sufficient rigidity can be maintained. Since the bead 94 is horizontally formed on the panel surface 90 and the rear wall surface 92 of the vehicle body inner-side reinforcement member 9 that constitutes the pillar reinforcement body 7, the pillar reinforcement body 7 can be maintained at sufficient strength.

Since the gap α is provided between the pillar reinforcement body 7 and the interior-side reinforcement member 10, the pillar reinforcement body 7 is locked onto the side body inner panel 4 and the interior-side reinforcement member 10 after the pillar reinforcement body 7 is rotationally moved some distance and thereby deformed. Since the pillar reinforcement body 7 is locked with high rigidity, deformation in association with further rotational movement is suppressed.

Since the pillar reinforcement body 7 forms the quadrangular closed section between the vehicle body outer-side reinforcement member 8 whose horizontal section is formed in a substantially L shape, and the vehicle body inner-side reinforcement member 9 whose horizontal section is formed in a substantially L shape, the assembling process is simplified, and the rigidity of the vehicle body inner-side reinforcement member 9 can be increased higher than that of the vehicle body outer-side reinforcement member 8 by providing the bead 94 on the vehicle body inner-side reinforcement member 9.

Also, since the interior-side reinforcement member 10 is disposed between the pillar reinforcement body 7 and the side body inner panel 4 with the gap α provided therebetween, the pillar reinforcement body 7 can be set so as to be locked onto the interior-side reinforcement member 10 after being rotationally moved some distance.

Since the interior-side reinforcement member 10 is disposed between the pillar reinforcement body 7 and the side body inner panel 4 with the gap a provided therebetween, a liquid remaining in the vehicle body structure when electrodeposition coating for anti-rust processing on the entire assembly or undercoating with a vehicle body color is performed can be effectively discharged after assembling of the body panels of the vehicle body.

Since an angle θ of the corner portion of the vehicle body inner-side reinforcement member 9 is formed as an angle close to a right angle, the pillar reinforcement body 7 can transmit the load to the interior-side reinforcement member 10 while holding the quadrangular closed section.

Please note that the present invention is not limited to the above embodiment, and for example, as long as the pillar reinforcement body 7 can form the quadrangular closed section, any vehicle body inner-side reinforcement member 9 that forms a quadrangular closed section such as square, rectangle, trapezoid, or rhombus in horizontal section may be used. When the angle θ of the corner portion of the vehicle body inner-side reinforcement member 9 is formed as an angle close to the right angle, the advantages of the above embodiment can be produced. Also, various modifications and changes may be made based on the technical concept of the present invention.

### REFERENCE SIGNS LIST

1 Vehicle body
2 Side body outer panel
2B Pillar portion
3 Side body
3a, 3b Opening portion
31a, 31b, 31c Slide rail
4 Side body inner panel
4B Pillar portion
5 Front door
6 Slide door
61a Upper portion roller
61b Lower portion roller
61c Intermediate portion roller
7 Pillar reinforcement body
7A Corner portion
8 Vehicle body outer-side reinforcement member
9 Vehicle body inner-side reinforcement member
10 Interior-side reinforcement, member
11 Striker
20 Vertical wall surface
65 Reinforcement member
67 Insertion port
80 Panel surface
81 Vertical wall surface
90 Panel surface
92 Rear wall surface
94 Bead
A Front pillar portion
B Quarter pillar portion (Pillar portion on a vehicle body front portion side of the opening portion 3b)
C Rear pillar portion (Pillar portion on a vehicle body rear portion side of the opening portion 3b)

1. A pillar structure for a vehicle body rear portion in which a slide door that opens and closes an opening portion provided in a vehicle side surface is provided, a pillar portion on a vehicle body rear portion side of the opening portion is composed of a closed section of an inner panel and an outer panel, and a fixing mechanism that fixes a rear portion of said slide door at a closed position of said slide door is provided at said pillar portion on the vehicle body rear portion side, wherein said fixing mechanism is provided on a surface facing a vehicle body front side of said pillar portion on the vehicle body rear portion side, a pillar reinforcement body that forms a quadrangular closed section in horizontal section is internally mounted to an inner surface of said pillar portion on the vehicle body rear portion side to which said fixing mechanism is mounted, and an interior-side reinforcement member is disposed between said pillar reinforcement body and said inner panel so as to have a gap in a vehicle width direction between the interior-side reinforcement member and said pillar reinforcement body.

2. The pillar structure for a vehicle body rear portion according to claim 1, wherein said pillar reinforcement body is formed by combining a vehicle body inner-side reinforcement member and a vehicle body outer-side reinforcement member whose horizontal sections are respectively formed in substantially L shapes; a front surface wall portion of said pillar portion on the vehicle body rear portion side is formed by said outer panel; a front surface portion of the vehicle body outer-side reinforcement member is overlapped on an inner wall surface of the front surface wall portion of said pillar portion on the vehicle body rear portion side; a rear surface portion of the vehicle body outer-side reinforcement member is extended to a vehicle body rear side; and the vehicle body inner-side reinforcement member that forms said quadrangular closed section together with said vehicle body outer-side reinforcement member is joined to a front end portion and a rear end portion of said vehicle body outer-side reinforcement member.

3. The pillar structure for a vehicle body rear portion according to claim 2, wherein a corner portion on a vehicle body rear outer side of said quadrangular closed section formed by said vehicle body outer-side reinforcement member and said vehicle body inner-side reinforcement member is formed as a substantially right angle in horizontal section.

4. The pillar structure for a vehicle body rear portion according to claim 3, wherein a reinforcement member is disposed in a vehicle body longitudinal direction at a bottom of a window portion of said slide door, and said fixing mechanism, said vehicle body outer-side reinforcement member, said vehicle body inner-side reinforcement member, and said interior-side reinforcement member are overlapped in vehicle body front view at a height of a lower end position of the reinforcement member.

5. The pillar structure for a vehicle body rear portion according to claim 1, wherein a corner portion on a vehicle body rear outer side of said quadrangular closed section formed by said vehicle body outer-side reinforcement member and said vehicle body inner-side reinforcement member is formed as a substantially right angle in horizontal section.

6. The pillar structure for a vehicle body rear portion according to claim 5, wherein a reinforcement member is disposed in a vehicle body longitudinal direction at a bottom of a window portion of said slide door, and said fixing mechanism, said vehicle body outer-side reinforcement member, said vehicle body inner-side reinforcement member, and said interior-side reinforcement member are overlapped in vehicle body front view at a height of a lower end position of the reinforcement member.

7. The pillar structure for a vehicle body rear portion according to claim 1, wherein a reinforcement member is disposed in a vehicle body longitudinal direction at a bottom of a window portion of said slide door, and said fixing mechanism, said vehicle body outer-side reinforcement member, said vehicle body inner-side reinforcement member, and said interior-side reinforcement member are overlapped in vehicle body front view at a height of a lower end position of the reinforcement member.
